(19) United States
(12) Patent Application Publication
(10) Pub. No.: US 2021/0110938 A1
(43) Pub. Date: Apr. 15, 2021

(54) METHOD AND APPARATUS FOR CONTROLLING A LOW ENERGY NUCLEAR REACTION

(71) Applicant: James F. Loan, Turner Falls, MA (US)

(72) Inventor: James F. Loan, Turner Falls, MA (US)

(21) Appl. No.: 16/600,061

(22) Filed: Oct. 11, 2019

(51) Int. Cl. G21B 3/00

(52) U.S. Cl. CPC G21B 3/002

(57) ABSTRACT

A method of terminating a reaction generating energy and ⁴He atoms from the reaction of three-dimensional nanostructured carbon material with deuterium gas. The method includes containing three-dimensional nanostructured carbon material in a sealable vessel, introducing deuterium gas to the vessel to react the three-dimensional nanostructured carbon material with the deuterium gas. The vessel is sealed to confine the reaction; and the reaction of the three-dimensional nanostructured carbon material with the deuterium gas is terminated by at least partially destroying the three-dimensional periodicity of the three-dimensional nanostructured carbon material in the vessel. An apparatus for generating energy and ⁴He atoms using a solid vessel having an interior cavity with three-dimensional nanostructured carbon material in the interior cavity in an amount sufficient to generate energy when deuterium gas is introduced to the vessel and reacts with the three-dimensional nanostructured carbon.

### FIELD OF USE

The present disclosure rates to a method and apparatus to terminate a low temperature nuclear reaction, control its output, and extract useful energy from a device using the reaction.

### BACKGROUND OF THE INVENTION

The environmental impact and cost of energy production has produced a long-standing need for efficient, clean, and affordable energy. While many “green” energy processes have been devised, all have significant drawbacks. While nuclear fission reactors have played a significant role in providing inexpensive electrical power, they have severe drawbacks. Fission reactions in commercial fission reactors emit levels of radiation that require massive shielding to make the reactor environment safe. The radiation makes the metallic reactor components intrinsically radioactive and degrades their properties. In addition, the prospect of a loss of coolant explosion with radioactive contaminants requires significant security measures and expensive system controls. Moreover, the spent nuclear fuel is dangerously radioactive for thousands of years and the problem of long term storage of spent nuclear fuel has not been solved. These drawbacks significantly limit the future of fission power reactors.

By contrast a power reactor based on a nuclear fusion reaction could produce abundant power without many of the problems of a fission reactor. The search for a commercial fusion-based power source has, however, proved unsuccessful.

There are two types of fusion-based power sources. First is the so called “hot fusion” technique, roughly analogous to a fission reaction, in that when it operates according to theory massive amounts of heat are generated in a nuclear reaction when deuterium atoms fuse. In practice such techniques have not achieved the theoretical potential and so much energy is input to the system that any excess energy produced is difficult to perceive. In such reactions either magnetic fields or focused lasers are used to raise the temperature and pressure of a plasma of the reactants to the millions of degrees Kelvin and millions of Newtons of pressure needed to overcome the repulsive Coulombic forces of the deuterium atoms and induce the fusion reaction. There is such a device at Lawrence Livermore National Laboratory. It drops deuterium/tritium pellets into a synchronized array of lasers that fire simultaneously to confine, compress, and heat the deuterium to a degree that a nuclear fusion reaction occurs for a very short time. After an expense of over $400 billion dollars, the device has yet to produce commercially significant amounts of energy.

The second type of fusion reaction is termed a Low Energy Nuclear Reaction (LENR) and involves nuclear reactions at the molecular level that give off energy at relatively low temperatures with no dangerous levels of radioactivity and no radioactive byproducts.

The energy produced by a controllable low temperature nuclear reaction (LENR) would have unprecedented effects on energy production worldwide. As the above cited DIA report states: “DIA assesses at high confidence that if LENR can produce nuclear source energy at room temperatures, this disruptive technology could revolutionize energy production and storage, since nuclear reactions produce millions of times more energy per unit mass than any know chemical fuel.” The positive economic and environmental ramifications of inexpensive energy, in amounts based on a controlled fusion reaction that produces no environmentally detrimental byproducts, would be beyond any known energy production method.

While the above cited application discloses the energy producing reaction, it does not disclose how the reaction is terminated or controlled. The present invention discloses both a method and apparatus to terminate the reaction, control its output, and extract useful energy from a device using the reaction.

### SUMMARY

In one embodiment, there is disclosed a method of terminating a reaction generating energy and ⁴He atoms from the reaction of three-dimensional nanostructured carbon material with deuterium gas. The three-dimensional nanostructured carbon material is contained in a sealable vessel and deuterium gas is introduced to the vessel to react the three-dimensional nanostructured carbon material with the deuterium gas. The vessel is sealed to confine the reaction. The reaction of the three-dimensional nanostructured carbon material with the deuterium gas is terminated by at least partially destroying the three-dimensional periodicity of the three-dimensional nanostructured carbon material in the vessel.

An apparatus embodiment generates energy and ⁴He atoms using a solid reactor vessel having an interior cavity with three-dimensional nanostructured carbon material in the interior cavity in an amount sufficient to generate energy when deuterium gas is introduced to the vessel and reacts with the three-dimensional nanostructured carbon. A conduit on the solid vessel provides flow communication to the interior cavity and a system in flow communication with the conduit for introducing or extracting gas into or from the interior cavity to terminate the reaction of deuterium with the three-dimensional nanostructured carbon material.

It is an object of the presently disclosed subject matter to provide methods and apparatus for controlling a low energy nuclear reaction. An object of the presently disclosed subject matter having been stated hereinabove, and which is achieved in whole or in part by the presently disclosed subject matter, other objects will become evident as the description proceeds when taken in connection with the accompanying drawings as best described below.

### BRIEF DESCRIPTION OF THE DRAWINGS

A full and enabling disclosure of the present subject matter is set forth more particularly in the remainder of the specification, including reference to the accompanying figures, in which:

FIG. 1 is a schematic view of a single-walled carbon nanotube (SWCNT).

FIG. 2 is a schematic view of a multi-walled carbon nanotube (MWCNT).

FIG. 3 is a cross-sectional view of a portion of an apparatus used to extract useful energy from a low energy nuclear reaction.

FIG. 4 is a schematic representation of a plurality of thermopiles on the exterior surface of a containment vessel.

FIG. 5 is a schematic representation of a gas supply system for introducing and removing gases into the interior of a reactor vessel to terminate or control the reaction taking place in the vessel.

### DESCRIPTION OF THE PREFERRED EMBODIMENTS

The following definitions are to be operative for this disclosure:

The term “nanotube” refers to a tubular-shaped, molecular structure generally having an average diameter in the inclusive range of 1-60 nm and an average length in the inclusive range of 0.1 nm to 250 nm.

The term “carbon nanotube” or any version thereof refers to a tubular-shaped, molecular structure composed primarily of carbon atoms arranged in a hexagonal lattice (a graphene sheet) which closes upon itself to form the walls of a seamless cylindrical tube. These tubular sheets can either occur alone (single-walled) or as many nested layers (multi-walled) to form the cylindrical structure. The term “energy” refers to nuclear, radiant or thermal energy eminating from the reaction of three-dimensional nanostructured carbon material with deuterium gas.

The term “radiation” refers to particles or electromagnetic waves including alpha particles, beta particles, neutrons, gamma-rays, and x-rays.

The term “nuclear fusion” is the process in which two or more atomic nuclei join together, or “fuse”, to form a single heavier nucleus. This is usually accompanied by the release or absorption of large quantities of energy in amounts far in excess of anything that could be obtained by a chemical reaction from an equivalent mass.

The term “local nuclear fusion” is defined as a distinct, localized, transient fusion event as opposed to a self-sustaining, high energy, nuclear reaction event.

The terms “nanostructured” refers to a structure or a material which possesses components having at least one dimension that is 100 nm or smaller.

The phrase “nanostructured material” refers to a material whose components have an arrangement that has at least one characteristic length scale that is 100 nanometers or less.

The phrase “periodicity of the nanostructured structure” refers to the repeating lattice-like structure of the individual nanotubes and the structure formed by concentric carbon nanotubes forming a multiwalled carbon nanotube.

U.S. patent application Ser. No. 13/089,986 published Oct. 20, 2011, which is herein incorporated by reference, discloses a method and apparatus for generating energy from the reaction of three-dimensional nanostructured carbon material and deuterium. That technology does not involve an electrochemical reaction of rare earth metals and deuterium, instead it uses the unique electrical environment and molecular structure of three-dimensional nanostructured carbon material such as carbon nanotubes to induce a local nuclear reaction between deuterium atoms. The application discloses that the structure of the three-dimensional nanostructured carbon materials create an environment that somehow overcomes the repulsive Coulombic forces that must be overcome to have Deuterium-Deuterium fusion. The results reported in that application are consistent with the known fusion reaction: 2D+2D->4He+23.8 MeV and thus create helium and energy from carbon nanotubes and deuterium. This technology that has the potential to revolutionize energy production. It requires no energy input, no expensive or restricted materials, and produces energy far in excess of what can be produced conventionally with no greenhouse gases or toxic byproducts.

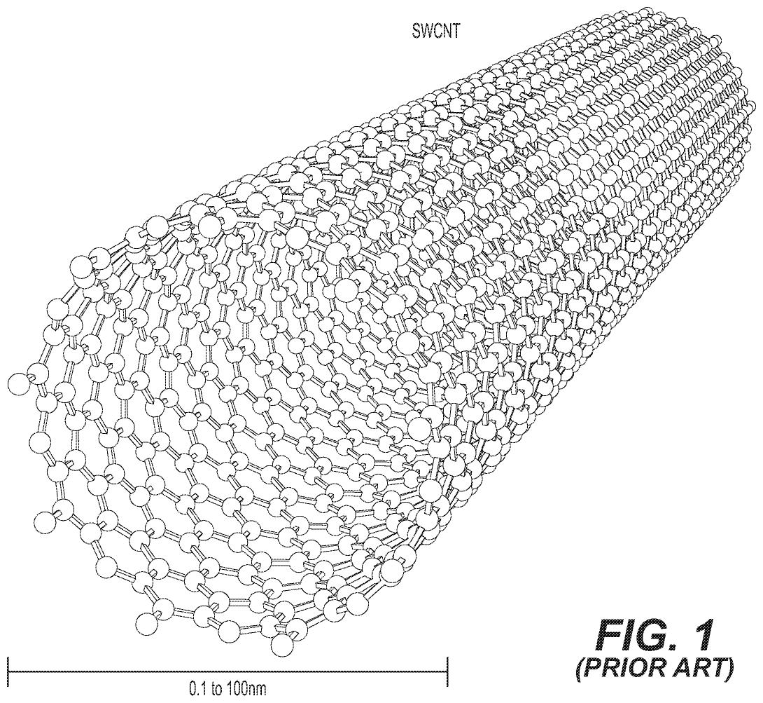

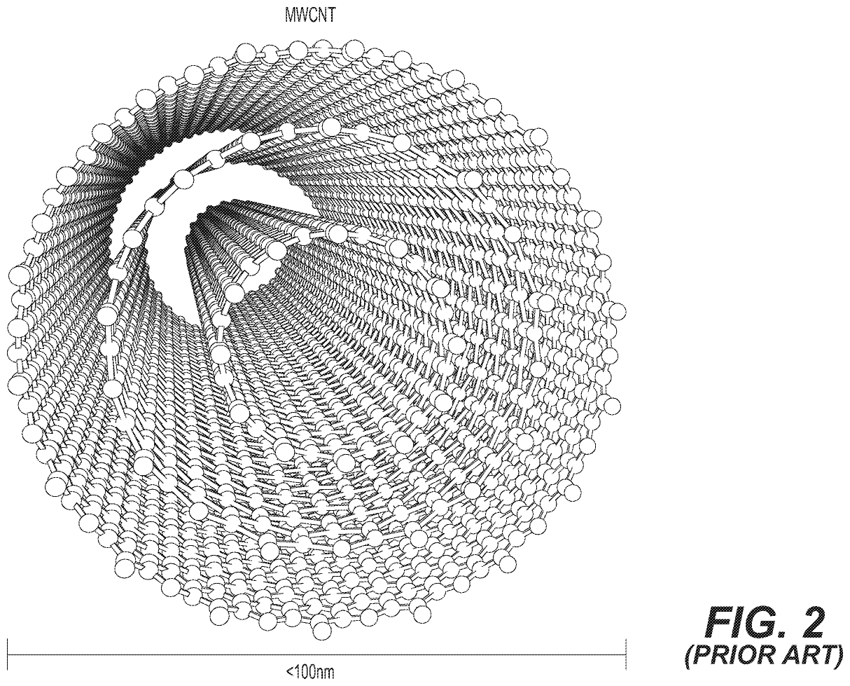

Carbon nanotubes (CNTs) have a unique structure, a diameter of about 1 nanometer (1/10,000,000 of a centimeter) and have been fabricated with length-to-diameter ratio of up to 132,000,000:1. The structure of a SWNT (single-walled carbon nanotubes) can be conceptualized by wrapping a one-atom-thick layer of graphite into a seamless cylinder. A graphic depiction of a SWNT is shown in FIG. 1. Multiwall carbon nanotubes (MWCNT's) have multiple concentric layers of that tubular structure A graphic depiction of a SWNT is shown in FIG. 2. Both forms of carbon nanotubes are available commercially. Deuterium is a non-radioactive isotope of hydrogen. For every 5,600 molecules of water on earth there is one molecule of what is called “heavy water” and it can be readily and economically separated from ordinary water. Heavy water (D2O) has the isotope of hydrogen (deuterium) in the water molecule rather than hydrogen. Just as hydrogen can exist in the form of an H2O molecule or a gas H2, deuterium can exist as D2O or the gas D2. Both forms of deuterium are available commercially.

### The Apparatus

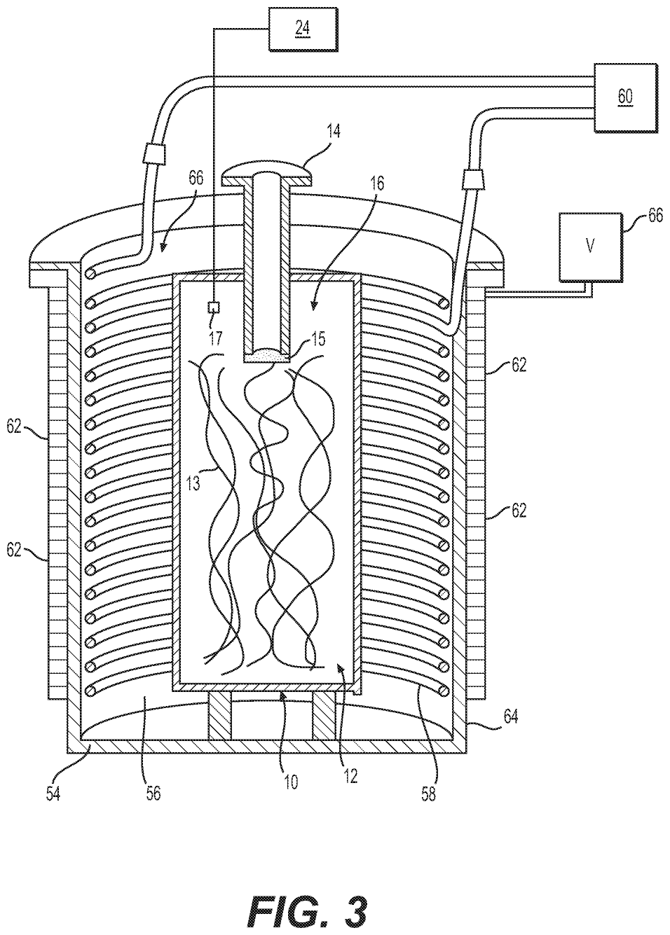

In accordance with the invention there is provided an apparatus for generating energy and ⁴He atoms. The apparatus includes a solid reactor vessel having an interior cavity. As here embodied, and depicted in FIG. 3, there is a solid cylindrical metal reactor vessel 10. In an embodiment, the solid cylindrical metal reactor vessel 10 is comprised of a material having a thermal conductivity greater than 100 W/(m·K), a density sufficient to moderate any Alpha particles emitted from the Deuterium-Deuterium reaction taking place in the reactor vessel and the mechanical strength to confine the materials within the vessel 10 at pressures created by the reaction or applied externally as a process variable.

As here embodied, the solid cylindrical metal reactor vessel 10 includes an interior cavity 12. The volume of the interior cavity 12 is determined by the desired output of the reactor, which is, in turn, determined by the amount and loading density of the carbon nanotubes placed in the cavity 12.

In accordance with the disclosure there is provided three-dimensional nanostructured carbon material in the interior cavity of the vessel that reacts with the three-dimensional nanostructured carbon to produce energy and ⁴He atoms. In an embodiment, the three-dimensional nanostructured carbon consists essentially of carbon nanotubes, such as multi-walled carbon nanotubes. Double-walled carbon nanotubes obtained from NanoTechLabs, Inc. in Yadkinville, N.C., USA designated as “C-Grade and M-Grade MWMTs” are known to be operable in such a reaction.

The three-dimensional nanostructured carbon material may also include other three-dimensional forms of nanostructure carbon including multilayer graphite, single walled carbon nanotubes, multiwalled carbon nanotubes, buckyballs, carbon onions, carbon nanohorns and combinations thereof. The three-dimensional nanostructured carbon materials can also be modified by adding a functional group to the surface of the carbon structure. The term “functional group” is defined as any atom or chemical group that provides a specific behavior. The term “functionalized” is defined as adding a functional group(s) to the surface of the nanotubes and/or the additional fiber that may alter the properties of the nanotube.

The three-dimensional nanostructured carbon material can also be modified by impregnating or filling the central opening in the structure with other atoms or clusters inside of nanotubes. The three-dimensional nanostructured carbon material can also be modified by substituting non-carbon atoms into the structure or by coating the outside of the structure with a layer of non-carbonaceous material. The three-dimensional nanostructured carbon material can also be modified by attaching nano-scale particles onto the outside of a structure.

In accordance with the disclosure there is provided a conduit on the solid vessel providing flow communication to the interior cavity. As here embodied, and depicted in FIG. 3 the vessel 10 includes a conduit 14 in flow communication with the interior cavity 12. The conduit 14 is intended to perform one or more function selected from introducing material into or from the interior cavity 12, removing material from the interior cavity 12, or controlling pressure in the cavity 12.

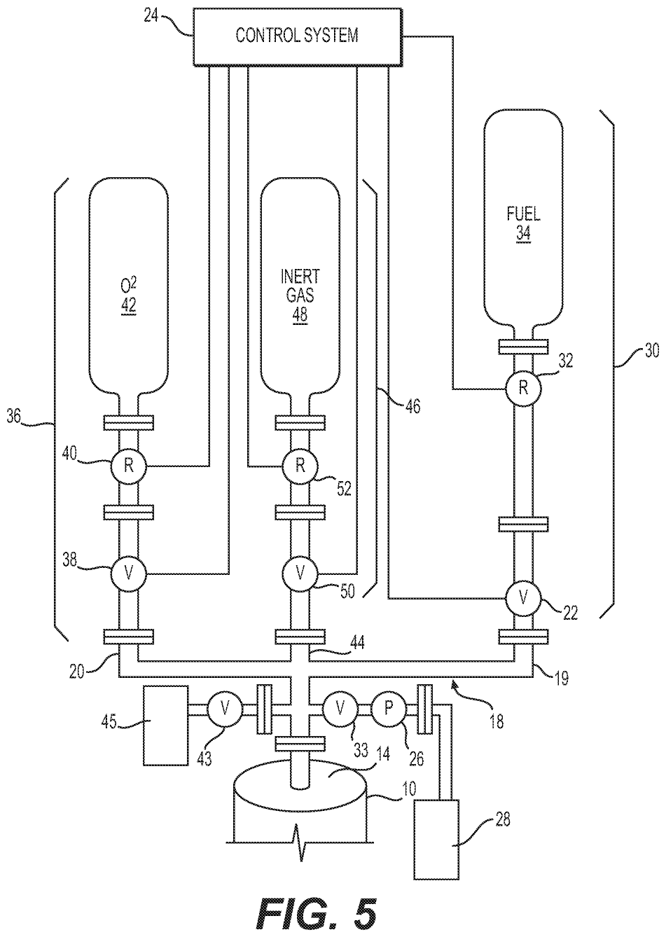

As here embodied, and depicted in FIG. 5 there is a manifold 18 having a minimum of three openings, a first gas inlet 19, in this embodiment disposed to allow the introduction of deuterium gas into the interior cavity 12 of the pressure vessel 10.

Additional valves (not shown) may be included to isolate the various components. The inlet 19 may include a first control valve 22 for regulating flow into the manifold 18. The first control valve 22 may be in communication with a control system 24 that controls the operation of of the valve 22. The other functions of the control system 24 will be disclosed below. The conduit 14 may also include a pump 26 in flow communication with the conduit 14. The pump 26 may be controlled by the control system 24 to evacuate the interior cavity 12 or regulate the pressure therein. A second control valve 33 may be placed between the conduit 14 and the pump 26 to isolate the pump from a first gas supply system 30. The first gas supply system 30 may be comprised of a first pressure regulator 32 optionally connected to the control system 24. The first gas supply system may include a first supply of gas 34. In this embodiment the first supply of gas 34 is disposed to supply pressurized deuterium gas through the first inlet 19 and ultimately to the interior cavity 12 of the reactor pressure vessel 10.

In accordance with the disclosure there is provided a system for inducing controlled combustion of the three-dimensional nanostructured carbon material in the interior cavity of the vessel to stop the reaction of the three-dimensional nanostructured carbon material with the deuterium gas. As here embodied, an oxidiner supply system 36 includes a second gas inlet 20 that may include a third control valve 38 for regulating flow of oxidizing gas to the manifold 18. The third control valve 38 may be in communication with a control system 24 that controls the operation of of the valve 38. The second gas supply system 36 may be comprised of a second pressure regulator 40 optionally connected to the control system 24. The second gas supply system 36 may include a second supply of pressurized gas 42. In this embodiment the second supply of gas 42 is disposed to supply oxygen gas through the second inlet 20 and ulitimately to the interior cavity 12 of the reactor pressure vessel 10. Preferably, if there is a headspace above the three-dimensional nanostructured carbon material 13, the pressure in the headspace is at a pressure below atmospheric pressure. As described in more detail below, and as shown in FIG. 3, the apparatus may include a heating element 17 in the headspace 13 to induce combustion within the pressure vessel 10. When the oxygen in the in the interior cavity 12 contacts the mixture of three-dimensional nanostructured carbon material and deuterium gas and the ignitor 17 is activated the carbon will be oxidized and converted to carbon monoxide, carbon dioxide, DO and D₂O (heavy water). An excess of oxygen will insure the resultant gas is carbon dioxide. The oxidation of the carbon will destroy the periodicity of the nanostructured carbon and the reaction of the nanostructured carbon with the deuterium will cease. As here embodied the apparatus may include a heating element 17 immersed in the deuterium gas in the headspace 13 above the mass of three-dimensional nanostructured carbon material 13 in the interior cavity 12. The heating element may be linked to the control system 24. The heating element 17 is used to induce combustion of the deuterium gas and three-dimensional nanostructured carbon material in the interior cavity 12. The apparatus may further include a blow-off valve 43 in flow communication with the conduit 14. If the combustion results in an undesirably high pressure, the blow-off valve 43 can vent pressure. As here embodied, the system includes and optional container 45 to receive the combustion gases. As here embodied and depicted in FIG. 3, the apparatus may further include a filter 15 in the conduit 14 to retain any solid materials, and especially the three-dimensional nanostructured carbon material 13 in the interior cavity 12.

As here embodied, and depicted in FIG. 5 the apparatus includes a third opening in the manifold 18, a gas inlet/gas outlet 44 used to control the pressure within the interior cavity 12 of the pressure vessel 10. The gas pressure regulator 32 on the first gas inlet 19 for supplying deuterium gas to the cavity 12 also be used to control the pressure in the cavity 12. The apparatus may include a third gas supply system 46 that includes a third gas supply valve 50, and a pressure regulator 52 controlled by the control system 24. The third gas inlet 44 may be used to introduce gas into the cavity 12 to moderate the reaction taking place therein. For example, an inert gas can be introduced to flush the deuterium gas from the cavity 12. While the residual deuterium bound in the three-dimensional nanostructured carbon would not be flushed from the cavity 12, unbound deuterium gas would be, and that would reduce the amount of deuterium gas in the system and influence the reaction rate. The introduction of inert gas can also be used to moderate or control the rate of the oxidation of the three-dimensional nanostructured carbon when an oxidizing gas is introduced to the cavity 12.

As here embodied and shown in FIG. 3, the apparatus may include a second vessel 54 surrounding the first vessel, forming a space 56 between the first and second vessels. The function of the space 56 is to receive and contain a material that provides radiation shielding and a thermal conduit to the second vessel. In an embodiment, the material is a slurry, or an aqueous solution. The composition of the slurry depends on the radiation being emitted and one skilled in the art of radiation shielding can readily select a material that will provide shielding for the intended environment of the apparatus. The amount of shielding is dependent on the type and amount of radiation emitted. For example, the shielding can include an aqueous borate solution or a slurry of boron compounds in a liquid vehicle. One skilled in the art of radiation shielding can readily select sufficient material to provide the shielding necessary for the environment of the device. When the device is intended to be used in proximity to personnel the level of radiation external to the device should comply with known standards. The mass of the shielding will be determined by the size of the reactor vessel, the emitted energy and the materials between the reacting materials and the exterior of the device. In some applications the material comprising the thermal conduit, in combination with the material comprising the pressure vessel 10, may be all that is necessary.

The apparatus may further include a heat exchanger within the space 56. As here embodied, and depicted in FIG. 3, a series of tubular coils 58 are located in the space 56. It is the function of the tubular coils 58 to extract heat from the material filling the space 56 by flowing a liquid coolant within the coils 58 and thereby maintain the material in the space 56 as a desired temperature. Depicted in FIG. 3 is a schematic temperature control system 60. It may optionally be linked with the control system 24 or the control system 24 may control the flow of liquid coolant and hence the temperature of the material in space 56.

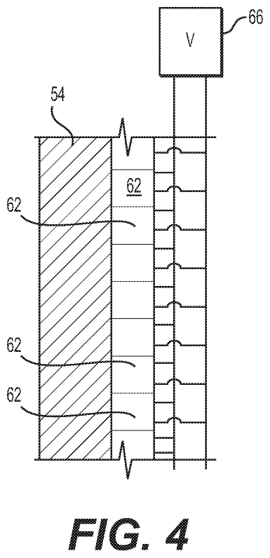

In an embodiment, the apparatus includes a system for converting energy emitted from the reaction of the deuterium and three-dimensional nanostructured carbon material to another form of energy. As presently understood, the reaction produces alpha particles that, upon acquiring electrons form helium and emit gamma rays, X-rays or both. One embodiment of the invention could include solid-state devices that convert gamma and/or X-rays directly to electricity. Examples of such devices are nanowires of zinc oxide in a silica aerogel and low thermal conductivity layered silicon-tin structures. Such a structure is disclosed in https://phys.org/news/2014-03-electricity.html#jCp. Still another example of such devices layered tiles of carbon nanotubes packed with gold and surrounded by lithium hydride. The radioactive particles collide with the gold and produce high-energy electrons. The electrons pass through carbon nanotubes into the lithium hydride and then into electrodes, allowing current to flow. See, US Patent Appln. 2013/0121449, published May 16, 2013, which is herein incorporated by reference. Alternatively, or in addition, another embodiment could include solid-state thermoelectric devices capable of converting heat generated by the reaction directly to electricity. As here embodied, and depicted in FIGS. 3 and 4 the apparatus includes a plurality of thermopiles 62 on the exterior surface 64 of the second vessel 54 that convert heat transmitted to surface 64 to electricity. The individual thermopiles 62 are conventionally wired to provide a voltage source 66. The thermopiles produce electricity based on the temperature differential between the outer wall of surface 64 and the surrounding ambient air. Thus, a balance must be kept between the internal cooling coils heat transport and the temperature needed for efficient operation of the thermopile

The apparatus of the present invention may also include various sensors that provide information about the temperature and pressure in various components of the system. One skilled in the art of process control can readily devise such systems without a specific teaching.

### The Processes

In accordance with the invention there is provided a method of terminating a reaction generating energy and ⁴He atoms from the reaction of three-dimensional nanostructured carbon material with deuterium gas.

In accordance with the disclosure the method includes the step of containing three-dimensional nanostructured carbon material in a sealable vessel. In an embodiment, the three-dimensional nanostructured carbon material is selected from the group consisting of multiwall carbon nanotubes, multilayer graphite, single walled carbon nanotubes, buckyballs, carbon onions, carbon nanohorns and combinations thereof.

In accordance with the disclosure, the method includes the step of introducing deuterium gas to the vessel to react the three-dimensional nanostructured carbon material with the deuterium gas. That reaction is believed to create Alpha particles and energy in the form of electromagnetic radiation.

In accordance with the disclosure, the method includes the step of sealing the vessel to confine the reaction. The pressure in the vessel may be monitored and controlled by the apparatus described above.

In accordance with the disclosure, the method includes the step of terminating the reaction of the three-dimensional nanostructured carbon material with the deuterium gas by at least partially destroying the three-dimensional periodicity of the three-dimensional nanostructured carbon material in the vessel. In an embodiment, an oxidizing gas is introduced to the mixture of three-dimensional nanostructured carbon material and the deuterium gas in the vessel. In this embodiment the oxidizing gas induces combustion of the nanostructured carbon material thereby destroying the three-dimensional periodicity of the three-dimensional nanostructured carbon material and stopping the reaction with the deuterium. The rate of addition of the oxidizing material to the vessel may also be used to control the reaction by not fully combusting the three-dimensional nanostructured carbon material with the deuterium gas by at least partially destroying the three-dimensional periodicity of the three-dimensional nanostructured carbon material in the vessel. In an embodiment the material used to oxidize the carbon material consists essentially of oxygen gas.

In accordance with the disclosure, there is also provided a method of controlling a reaction generating energy and ₄He atoms from the reaction of three-dimensional nanostructured carbon material with deuterium gas. In this method three-dimensional nanostructured carbon material is contained in a sealable vessel and deuterium gas is introduced to the vessel to react with the three-dimensional nanostructured carbon material. The vessel is sealed to confine the reaction. The vessel is surrounded with a heat extracting medium and the temperature of the medium is controlled to control the rate of the reaction of the three-dimensional nanostructured carbon material with the deuterium gas by introducing inert gas into the vessel.

An operation of the embodiment may include the following steps. The interior cavity 12 of the pressure vessel 10 is pumped to below a Torr in pressure. The interior cavity is then backfilled with dry nitrogen. The pressure in the interior cavity is monitored and the pumping and backfilling repeated until the rate of pressure increase after pumping indicates that the interior cavity and the three-dimensional nanostructured carbon material in the cavity are sufficiently moisture free. As used herein, sufficiently moisture free means less than 3% moisture, such as less than 1% moisture, or even less than 0.05% by weight of moisture. The interior cavity 12 (containing the dried three-dimensional nanostructured carbon material) is backfilled with deuterium gas (D²) to approximately 100 Torr. by means of the deuterium supply 34, the first pressure regulator 32 and the valves 22, 33, 38, 43, and 50. The D² and the three-dimensional nanostructured carbon material then react and the process is initiated.

As disclosed above, the reaction can be shut down and energy production halted by inducing combustion of the three-dimensional nanostructured carbon material. As here embodied, the three-dimensional nanostructured carbon material 13 in the interior cavity 12 are combusted by heating the heating element 17 while controlling the gas composition in the cavity 12 with the oxygen supply 42 and optionally the inert gas supply 48. The heating element 17 is immersed in the deuterium gas above the mass of three-dimensional nanostructured carbon material 13. The gases that are not bound to the three-dimensional nanostructured carbon material (primarily deuterium gas and helium) are pumped out by the pump 26. The heating element 17 is activated and the valves 33, 38, 50, and 22 are configured to introduce oxygen from oxidizer supply 42 to the interior 12. The amount of oxygen introduced will depend on the mass of three-dimensional nanostructured carbon material and unbound deuterium gas in the interior 12.

In an embodiment, there is a stoichiometric excess of oxygen in the interior. The oxygen will mix with the unbound deuterium gas and infiltrate the mass of three-dimensional nanostructured carbon material 13. The induced combustion will oxidize the three-dimensional nanostructured carbon material and the deuterium gas to form D2O (heavy water) and carbon dioxide. These gasses can be removed from the system by the pump 26. As disclosed above, for safety purposes the blow-off valve 43 and the container 45 may be used to control the disposition of high-pressure combustion gases.

As here embodied, the inert gas supply 48 and the associated regulator 52 and valve 50 can be configured to control the introduction of inert gas into the interior 12 of the vessel 10 to control the combustion reaction described above. As used here, the term inert gas can include truly inert gases such as argon and helium, but may also include gases such as nitrogen or carbon dioxide.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention.

Other embodiments of the invention will be apparent to those skilled in the art from consideration of the specification and practice of the invention disclosed herein. It is intended that the specification and examples be considered as exemplary only, with the true scope of the invention being indicated by the following claims.

What is claimed is:

1. A method of terminating a reaction generating energy and ⁴He atoms from the reaction of three-dimensional nanostructured carbon material with deuterium gas, said method comprising:
containing three-dimensional nanostructured carbon material in a sealable vessel;
introducing deuterium gas to said vessel to react the three-dimensional nanostructured carbon material with the deuterium gas;
sealing the vessel to confine the reaction; and
terminating the reaction of the three-dimensional nanostructured carbon material with the deuterium gas by at least partially destroying the three-dimensional periodicity of the three-dimensional nanostructured carbon material in the vessel.

2. The method of claim 1, wherein the at least partial destruction of the three-dimensional periodicity of the three-dimensional nanostructured carbon material comprises the step of inducing combustion of the three-dimensional nanostructured carbon material.

3. The method of claim 2 wherein the combustion is induced by the introduction of a material that will oxidize the carbon material into the vessel.

4. The method of claim 3, wherein said material that will oxidize the carbon material consists essentially of oxygen gas.

5. The method of claim 1, wherein the three-dimensional nanostructured carbon material undergoes combustion.

6. The method of claim 1, wherein the three-dimensional periodicity of the three-dimensional nanostructured carbon material is substantially destroyed.

7. The method of claim 1, wherein the three-dimensional nanostructured carbon material consists essentially of multiwall carbon nanotubes.

8. A method of controlling a combustion reaction used to terminate a reaction generating energy and ⁴He atoms from the reaction of three-dimensional nanostructured carbon material with deuterium gas, comprising introducing inert gas into the vessel.

9. The method of claim 8, including the step of changing the pressure in said vessel.

10. An apparatus for generating energy and ⁴He atoms, said apparatus comprising:
a solid reactor vessel having an interior cavity;
three-dimensional nanostructured carbon material in the interior cavity in an amount sufficient to generate energy when deuterium gas is introduced to the vessel and reacts with the three-dimensional nanostructured carbon to produce energy and ⁴He atoms;
a conduit on the solid reactor vessel providing flow communication to the interior cavity; and
a system in flow communication with said conduit for introducing or extracting gas into or from said interior cavity to terminate the reaction of deuterium with the three-dimensional nanostructured carbon material.

11. The apparatus of claim 10, including a system for inducing controlled combustion of the three-dimensional nanostructured carbon material in the interior cavity of the vessel through the conduit to stop the reaction of the three-dimensional nanostructured carbon material with the deuterium gas.

12. The apparatus of claim 11, including a source of deuterium gas in flow communication with the interior cavity through the second interface.

13. The apparatus of claim 11, including a source of an oxidizing material in flow communication with said conduit.

14. The apparatus of claim 13, wherein said oxidizing material comprises oxygen gas.

15. The apparatus of claim 10, including a second vessel surrounding said first vessel, forming a space between said first and second vessels.

16. The apparatus of claim 15, further including radiation shielding material in said space.

17. The apparatus of claim 16, wherein said shielding material comprises an aqueous solution.

18. The apparatus of claim 15, further including a heat exchanger within said space.

19. The apparatus of claim 16, wherein said apparatus includes at least one thermopile on the exterior surface of said second vessel.

20. The apparatus of claim 10, wherein the three-dimensional nanostructured carbon material consists essentially of multiwall carbon nanotubes.

21. The apparatus of claim 10, further including a system for converting the energy from the reaction to another form of energy.

22. The apparatus of claim 21, wherein said system for converting energy from the reaction comprises at least one thermopile.

23. The apparatus of claim 10, wherein the energy generated includes radiation and the apparatus further includes a solid-state device for converting radiation directly to electricity.

24. The apparatus of claim 10 including a source of deuterium gas in flow communication with said interior cavity in said reactor vessel.

25. An apparatus for generating energy and ⁴He atoms, said apparatus comprising:
three-dimensional nanostructured carbon material in an amount sufficient to react with deuterium gas and produce radiation and ⁴He atoms; and
a solid-state device for converting radiation directly to electricity.
